(19) United States
(12) Patent Application Publication
(10) Pub. No.: US 2010/0169493 A1
(43) Pub. Date: Jul. 1, 2010

(54) SYSTEM AND METHOD OF SWITCHING FROM STREAMING CONTENT TO LOCAL CONTENT

(76) Inventors: Devender YAMAKAWA, San Diego, CA (US); Virginia Walker KEATING, San Diego, CA (US); Jee PARK, San Francisco, CA (US)

Correspondence Address: QUALCOMM INCORPORATED, 5775 MOREHOUSE DR., SAN DIEGO, CA, 92121, US

(21) Appl. No.: 12/344,567

(22) Filed: Dec. 28, 2008

(51) Int. Cl. G06F 15/16

(52) U.S. Cl. 709/227; 709/231

(57) ABSTRACT

A method of receiving streaming music at a wireless device is provided. The method includes receiving a music stream from a server, emitting music from the music stream, and playing a locally stored song, when a network interruption is detected. The method may further include accessing a playlist and determining whether the playlist includes at least one of a user favorite song, a same artist song, or a same genre song. Moreover, the method may also include determining that a network connection is re-established, finishing playback of the locally stored song, receiving another music stream from the server, and emitting music from the other music stream.

### BACKGROUND

The present invention generally relates to the operation of data networks, and more particularly, to systems and methods of listening to music via a network device.

Advances in technology have resulted in the development and deployment of extensive data networks. These networks include both public data networks, such as the Internet, and specialized networks, such as wireless telecommunication networks. Users of these networks have the ability to access a wide variety of information and services that are available as network resources.

One example where there is an increasing demand for network resources is in wireless network environments. In wireless environments, a variety of wireless devices, such as wireless telephones, personal digital assistants (PDAs), and paging devices, communicate over a wireless network. The wireless network may also include network servers that operate to provide various network resources to the wireless devices. Furthermore, the wireless networks may also be coupled to a public network, such as the Internet, so that resources on the public network may be made available to the wireless devices on the wireless network.

In one particular area, users may download or stream songs and other content to a wireless device via a wireless network. A user may listen to, or otherwise view, content using a wireless device. Listening to music streamed over a wireless network on a mobile device is prone to interruption due to losses in network connectivity. These losses of connectivity may occur for a variety of reasons, e.g., environmental reasons, system initiated reasons, user initiated reasons, etc. From a user's standpoint, losing connectivity when listening to streaming music may be very frustrating.

Therefore, what is needed is a system and method that compensates for network interruptions when listening to streaming music via a wireless device.

### SUMMARY OF THE DISCLOSURE

The following presents a simplified summary in order to provide a basic understanding of some aspects of the disclosed versions. This summary is not an extensive overview and is intended to neither identify key or critical elements nor delineate the scope of such versions. Its purpose is to present some concepts of the described versions in a simplified form as a prelude to the more detailed description that is presented later.

A method of receiving streaming music at a wireless device is disclosed and includes receiving a music stream from a server, emitting music from the music stream, and playing a locally stored song, when a network interruption is detected.

In this aspect, the method may further include accessing a playlist and determining whether the playlist includes one of a user favorite song, a same artist song, or a same genre song. The locally stored song may be selected from the group including the user favorite song, the same artist song, the same genre song, and a random song. The method may also include determining that a network connection is re-established, finishing playback of the locally stored song, receiving another music stream from the server, and emitting music from the other music stream. Further, the method may include determining that a network connection is re-established, ceasing playback of the locally stored song, receiving another music stream from the server, and emitting music from the other music stream.

In another aspect, a wireless device used to access content is disclosed. The wireless device may include means for receiving a music stream from a server, means for emitting music from the music stream, and means for playing a locally stored song, when a network interruption is detected. The wireless device may also include means for accessing a playlist and means for determining whether the playlist includes at least one of a user favorite song, a same artist song, or a same genre song. The locally stored song may be selected from a group including the user favorite song, the same artist song, the same genre song, and a random song.

In this aspect, the wireless device may further include means for determining that a network connection is re-established, means for finishing playback of the locally stored song, means for receiving another music stream from the server, and means for emitting music from the other music stream. Also, the wireless device may include means for determining that a network connection is re-established, means for ceasing playback of the locally stored song, means for receiving another music stream from the server, and means for emitting music from the other music stream.

In yet another aspect, a wireless device used to access content is disclosed and may include a processor. The processor may be operable to receive a music stream from a server, to emit music from the music stream, and to play a locally stored song, when a network interruption is detected. The processor may be further operable to access a playlist and to determine whether the playlist includes at least one of a user favorite song, a same artist song, and a same genre song. The locally stored song may be selected from a group including the user favorite song, the same artist song, the same genre song, and a random song.

In this aspect, the processor may be operable to determine that a network connection is re-established, finish playback of the locally stored song, receive another music stream from the server, and emit music from the other music stream. Moreover, the processor is operable to determine that a network connection is re-established, cease playback of the locally stored song, receive another music stream from the server, and emit music from the other music stream.

In still another aspect, a computer program device is disclosed and may include a computer-readable medium. The computer-readable medium may include at least one instruction for receiving a music stream from a server, at least one instruction for emitting music from the music stream, and at least one instruction for playing a locally stored song, when a network interruption is detected. The computer-readable medium may also include at least one instruction for accessing a playlist and at least one instruction for determining whether the playlist includes at least one of a user favorite song, a same artist song, or a same genre song. The locally stored song is selected from a group including the user favorite song, the same artist song, the same genre song, and a random song.

In this aspect, the computer-readable medium may include at least one instruction for determining that a network connection is re-established, at least one instruction for finishing playback of the locally stored song, at least one instruction for receiving another music stream from the server, and at least one instruction for emitting music from the other music stream. Also, the computer-readable medium may include at least one instruction for determining that a network connection is re-established, at least one instruction for ceasing playback of the locally stored song, at least one instruction for receiving another music stream from the server, and at least one instruction for emitting music from the other music stream.

In another aspect, a method of transmitting streaming music to a wireless device is disclosed and may include receiving a request to join a music stream from a user device, generating a playlist at least partially based on a next song, transmitting the playlist to the user device, and transmitting the music stream to the user device. The playlist may include a plurality of songs stored locally at the user device. Further, the playlist may include at least one of a user favorite song, a same artist song, or a same genre song.

In this aspect, the method may include determining a next song to stream, determining that the next song is a different artist song, and generating another playlist at least partially based on the different artist song. Moreover, the method may include transmitting the other playlist to the user device and transmitting the next song to the user device via the music stream. Also, the method may include determining a next song to stream, determining that the next song is a different genre song, and generating another playlist at least partially based on the different genre song. Further, the method may include transmitting the other playlist to the user device and transmitting the next song to the user device via the music stream.

In still another aspect, a server is disclosed and may include means for receiving a request to join a music stream from a user device, means for generating a playlist at least partially based on a next song, means for transmitting the playlist to the user device, and means for transmitting the music stream to the user device. The playlist may include a plurality of songs stored locally at the user device. Additionally, the playlist may include at least one of a user favorite song, a same artist song, or a same genre song.

In this aspect, the server may also include means for determining a next song to stream, means for determining that the next song is a different artist song, and means for generating another playlist at least partially based on the different artist song. The server may include means for transmitting the other playlist to the user device and means for transmitting the next song to the user device via the music stream. Further, the server may include means for determining a next song to stream, means for determining that the next song is a different genre song, and means for generating another playlist at least partially based on the different genre song. The server may also include means for transmitting the other playlist to the user device and means for transmitting the next song to the user device via the music stream.

In yet another aspect, a server is disclosed and may include a processor that is operable to receive a request to join a music stream from a user device, to generate a playlist at least partially based on a next song, to transmit the playlist to the user device, and to transmit the music stream to the user device. The playlist may include a plurality of songs stored locally at the user device. More specifically, the playlist may include at least one of a user favorite song, a same artist song, or a same genre song.

In this aspect, the processor may be operable to determine a next song to stream, to determine that the next song is a different artist song, and to generate another playlist at least partially based on the different artist song. Further, the processor may be operable to transmit the other playlist to the user device and to transmit the next song to the user device via the music stream. The processor may be operable to determine a next song to stream, determine that the next song is a different genre song, and generate another playlist at least partially based on the different genre song. The processor may also be operable to transmit the other playlist to the user device and transmit the next song to the user device via the music stream.

In another aspect, a computer program device is disclosed and may include a computer-readable medium. The computer-readable medium may include at least one instruction for receiving a request to join a music stream from a user device, at least one instruction for generating a playlist at least partially based on a next song, at least one instruction for transmitting the playlist to the user device, and at least one instruction for transmitting the music stream to the user device. The playlist may include a plurality of songs stored locally at the user device. Further, the playlist further may include at least one of a user favorite song, a same artist song, or a same genre song.

In this aspect, the computer-readable medium may include at least one instruction for determining a next song to stream, at least one instruction for determining that the next song is a different artist song, and at least one instruction for generating another playlist at least partially based on the different artist song. Moreover, the computer-readable medium may include at least one instruction for transmitting the other playlist to the user device and at least one instruction for transmitting the next song to the user device via the music stream. The computer-readable medium may also include at least one instruction for determining a next song to stream, at least one instruction for determining that the next song is a different genre song, and at least one instruction for generating another playlist at least partially based on the different genre song. Further, the computer-readable medium may include at least one instruction for transmitting the other playlist to the user device and at least one instruction for transmitting the next song to the user device via the music stream.

To the accomplishment of the foregoing and related ends, one or more versions comprise the features hereinafter fully described and particularly pointed out in the claims. The following description and the annexed drawings set forth in detail certain illustrative aspects and are indicative of but a few of the various ways in which the principles of the versions may be employed. Other advantages and novel features will become apparent from the following detailed description when considered in conjunction with the drawings and the disclosed versions are intended to include all such aspects and their equivalents.

### BRIEF DESCRIPTION OF THE DRAWINGS

In the figures, like reference numerals refer to like parts throughout the various views unless otherwise indicated.

FIG. 1 is a diagram of a data network, according to one aspect;

FIG. 2 is a diagram of a server, according to one aspect;

FIG. 3 is a diagram of a wireless device, according to one aspect;

FIG. 4 is a flowchart illustrating method of replacing streaming music with local music when a network connection to a wireless device is interrupted, according to one aspect; and

FIG. 5 is a flowchart illustrating a method of generating a play list associated with streaming music to a wireless device, according to one aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to concisely describing these versions.

In this description, the word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as object code, scripts, byte code, markup language files, and patches. In addition, an “application” referred to herein, may also include files that are not executable in nature, such as documents that may need to be opened or other data files that need to be accessed.

The term “content” may also include files having executable content, such as object code, scripts, byte code, markup language files, and patches. In addition, a “content” referred to herein, may also include files that are not executable in nature, such as documents that may need to be opened or other data files that need to be accessed.

In this description, the terms “communication device,” “wireless device,” “wireless telephone,” “wireless communications device,” and “wireless handset” are used interchangeably. With the advent of third generation (3G) wireless technology, more bandwidth availability has enabled more electronic devices with wireless capabilities. Therefore, a wireless device could be a cellular telephone, a pager, a PDA, a smartphone, a navigation device, or a computer with a wireless connection.

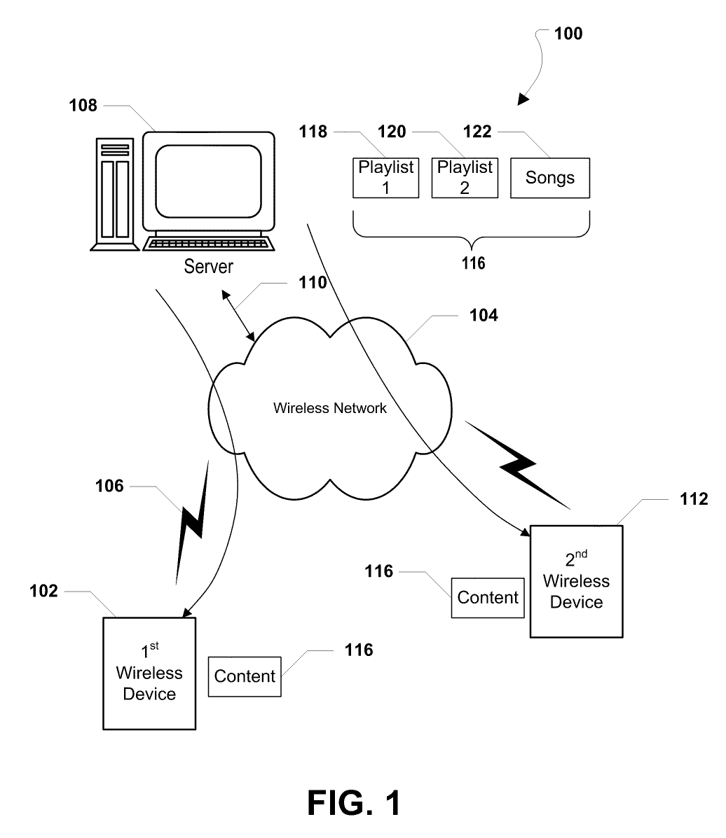

FIG. 1 shows a data network 100, according to one aspect. The network 100 may include a first wireless device 102 that communicates with a wireless data network 104 via a wireless communication channel 106. The network 100 may also include a server 108 that operates to provide services to the first wireless device 102 and other entities in communication with the network 104. The server 108 may be coupled to the network 104 by link 110, which may be any type of wired or wireless link. For example, in one aspect, the wireless device 102 may be a wireless telephone, and the server 108 may be part of a nationwide telecommunications network that provides applications and/or multimedia content to the device 102. A second wireless device 112 may also be coupled to the network 104.

In a particular aspect, the server 108 may transmit, or otherwise provide, streaming content 116 to the first wireless device 102, the second wireless device 112, or a combination thereof. The streaming content 116 may include a first playlist 118, a second playlist 120, and one or more songs 122. In a particular aspect, the server 108 may transmit the streaming content 116 to a wireless device 102, 112. In the event of a network interruption, and as described in detail herein, a playlist 118, 120, associated with the streaming content 116 and transmitted to the wireless device 102, 112, may be used by the wireless device 102, 112 to select a song stored locally at the wireless device 102, 112. The locally stored song may be used to replace the streaming song from the server 108 that ended due to the network interruption.

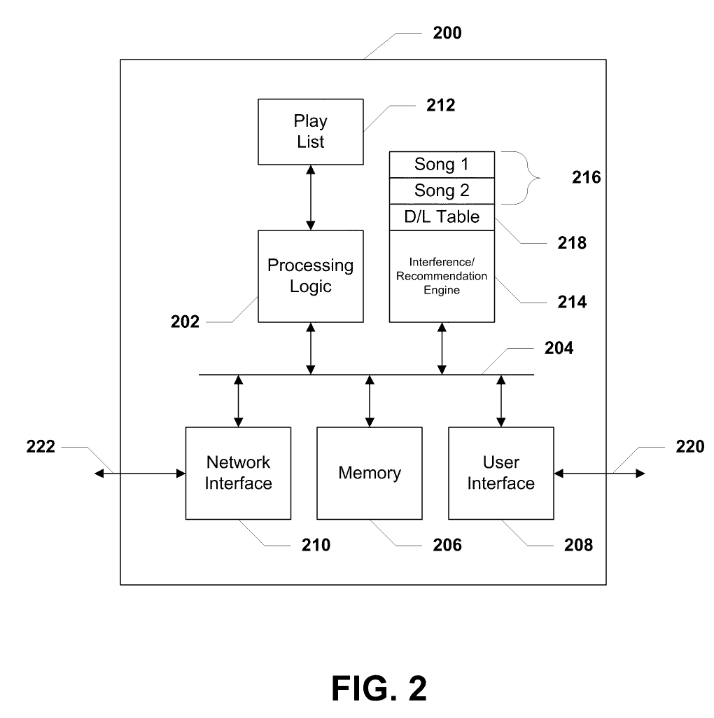

FIG. 2 shows a functional block diagram illustrating one aspect of a server 200 that is operable to deliver streaming content to one or more wireless devices over a wireless data network. As depicted in FIG. 2, the server 200 may include processing logic 202 that is coupled to an internal data bus 204. Also coupled to the internal data bus 204 are a memory 206, a user interface 208, and a network interface 210. The server 200 may also include a playlist 212 that may be accessible to the processing logic 202 and an inference/recommendation engine 214 coupled to the internal bus 204. The interference/recommendation engine 214 may be an application stored in a memory that may be executed by the processing logic 202. The interference/recommendation engine 214 and the processing logic 202 may be operable to execute one or more of the method steps described herein. One or more of the method steps may be stored as instructions, e.g., within the memory 206. The interference/recommendation engine 214 may include one or more songs 216 that may be streamed to a wireless device. Further, the interference/recommendation engine 214 may include a download table 218 in which songs that are downloaded, or streamed, to a wireless device may be stored. The download table 218 may be used to generate the playlist 212.

In one or more aspects, the processing logic 202 comprises a CPU, a gate array, hardware logic, software, or a combination of hardware and software. Thus, the processing logic 202 may generally include logic to execute machine-readable instructions. In other words, the processing logic 202 may act as a means for executing one or more computer programs that may include the method steps disclosed herein.

The memory 206 may include random access memory (RAM), read only memory (ROM), flash memory, electrically erasable read only memory (EEROM), or any other suitable type of memory, or a combination thereof. In one aspect, the memory 206 is located internally to the server 200. In another aspect, the memory 206 comprises a removable memory card or memory device that may be selectively attached to the server 200 and thereby being coupled to the internal bus 204. Thus, the memory 206 may comprise virtually any type of memory that is capable of storing instructions that may be executed by the processing logic 202.

The user interface 208 may receive user input 220, for example, from a keypad, a pointing device, a touch pad, or any other input mechanisms which allow a user to interact with the server 200. The user interface 208 may also be coupled to a display device, such as a cathode ray tube (CRT) display, a liquid crystal display (LCD), a light emitting diode (LED), or any other type of display device to provide a visual display to the user. Any other type of input or output device may also be coupled to the user interface 208, such as, disk storage, audio logic, video devices, etc.

The network interface 210 operates to transmit and receive information between the server 200 and external devices, systems, and/or networks using a communication link 222. For example, in one aspect, the network interface 210 comprises a radio transceiver circuit (not shown) that operates to transmit and receive information over a wireless data network using the communication link 222. For example, the communication link 222 may be the communication link 106 shown in FIG. 1. For example, the transceiver comprises circuitry that modulates information received from the processing logic 202 and converts the modulated information into high frequency signals suitable for wireless transmission. Similarly, the transceiver also comprises circuitry to convert received high frequency communication signals into signals suitable for demodulation and subsequent processing by the processing logic 202.

In another aspect, the network interface 210 comprises a transceiver that operates to transmit and receive information over a hardwired communication link, such as a telephone line, or other type of data line, to communicate with a remote system on a public data network, such as the Internet.

In still another aspect, the network interface 210 comprises circuitry that operates to communicate with local devices, such as a local workstation. The network interface 210 may also include circuitry (such as serial or parallel port logic) to communicate with a printer or other local computer or device, such as a floppy disk or a memory card. Thus, the network interface 210 may comprise any type of hardware, software, or combination thereof to allow the server 200 to communicate with other local or remotely located devices or systems.

In one aspect, the server 200 may stream one or more songs to a wireless device via the network interface 21 0. Along with the streaming content, the server 200 may transmit the playlist 212 to the wireless device. The playlist 212 may be generated by the interference/recommendation engine based on a history of downloads or a history of streaming content stored in the download table 218. If a network connection to a wireless device is interrupted, the wireless device may use the playlist 212 to choose a suitable song stored locally on the wireless device to replace the streaming song that ends due to the network interruption.

During operation of the server 200, the processing logic 202 may execute program instructions stored in the memory 206 to perform the functions described herein. For example, in one aspect, the server 200 may perform the described functions when the processing logic 202 executes program instructions stored in the memory 206. In another aspect, the program instructions are stored on a computer-readable medium, such as a floppy disk, a compact disc (CD), a memory card, a flash memory device, a ROM, or any other type of memory device. The program instructions may be loaded into the memory 206 via the network interface 210. For example, the server 200 may download the program instructions from the computer-readable medium into the memory 206 via the network interface 210.

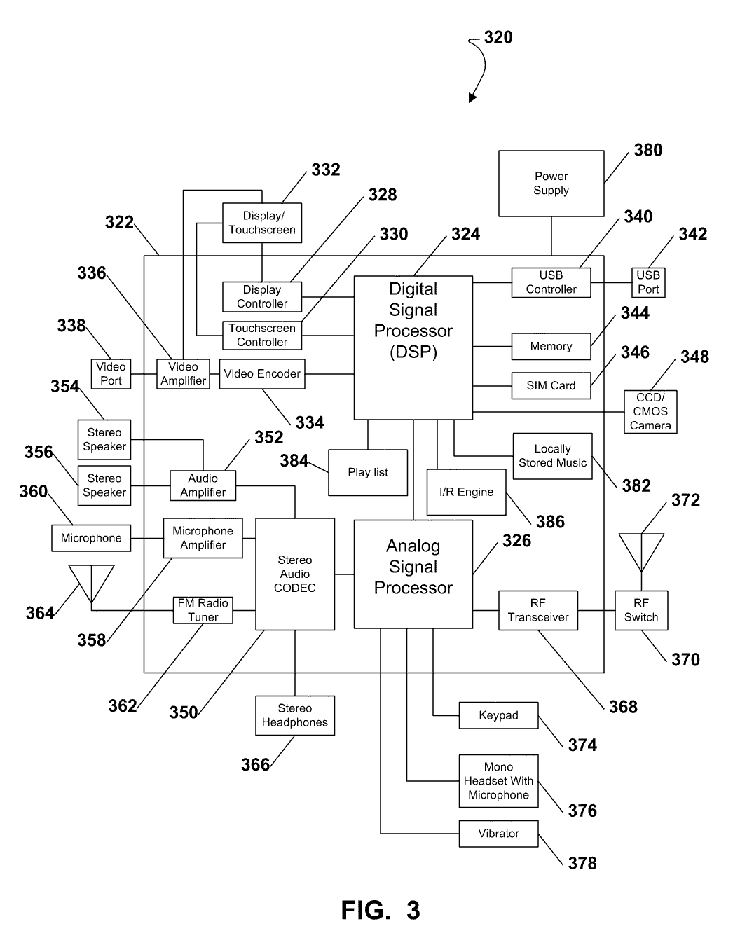

Referring to FIG. 3, an exemplary, non-limiting aspect of a wireless device is shown and is generally designated 320. As shown, the wireless device 320 includes an on-chip system 322 that includes a digital signal processor 324 and an analog signal processor 326 that are coupled together. As illustrated in FIG. 3, a display controller 328 and a touchscreen controller 330 are coupled to the digital signal processor 324. In turn, a touchscreen display 332 external to the on-chip system 322 is coupled to the display controller 328 and the touchscreen controller 330.

FIG. 3 further indicates that a video encoder 334, e.g., a phase alternating line (PAL) encoder, a sequential couleur a memoire (SECAM) encoder, or a national television system(s) committee (NTSC) encoder, is coupled to the digital signal processor 324. Further, a video amplifier 336 is coupled to the video encoder 334 and the touchscreen display 332. Also, a video port 338 is coupled to the video amplifier 336. As depicted in FIG. 3, a universal serial bus (USB) controller 340 is coupled to the digital signal processor 324. Also, a USB port 342 is coupled to the USB controller 340. A memory 344 and a subscriber identity module (SIM) card 346 may also be coupled to the digital signal processor 324. Further, as shown in FIG. 3, a digital camera 348 may be coupled to the digital signal processor 324. In an exemplary aspect, the digital camera 348 is a charge-coupled device (CCD) camera or a complementary metal-oxide semiconductor (CMOS) camera.

As further illustrated in FIG. 3, a stereo audio CODEC 350 may be coupled to the analog signal processor 326. Moreover, an audio amplifier 352 may be coupled to the stereo audio CODEC 350. In an exemplary aspect, a first stereo speaker 354 and a second stereo speaker 356 are coupled to the audio amplifier 352. FIG. 3 shows that a microphone amplifier 358 may be also coupled to the stereo audio CODEC 350. Additionally, a microphone 360 may be coupled to the microphone amplifier 358. In a particular aspect, a frequency modulation (FM) radio tuner 362 may be coupled to the stereo audio CODEC 350. Also, an FM antenna 364 is coupled to the FM radio tuner 362. Further, stereo headphones 366 may be coupled to the stereo audio CODEC 350.

FIG. 3 further indicates that a radio frequency (RF) transceiver 368 may be coupled to the analog signal processor 326. An RF switch 370 may be coupled to the RF transceiver 368 and an RF antenna 372. As shown in FIG. 3, a keypad 374 may be coupled to the analog signal processor 326. Also, a mono headset with a microphone 376 may be coupled to the analog signal processor 326. Further, a vibrator device 378 may be coupled to the analog signal processor 326. FIG. 3 also shows that a power supply 380 may be coupled to the on-chip system 322. In a particular aspect, the power supply 380 is a direct current (DC) power supply that provides power to the various components of the wireless device 320 that require power. Further, in a particular aspect, the power supply is a rechargeable DC battery or a DC power supply that is derived from an alternating current (AC) to DC transformer that is connected to an AC power source.

FIG. 3 also shows that the wireless device 320 may also include locally stored music 382 that may include one or more songs. The locally stored music 382 may be transmitted to the wireless device 320 from a server via a wireless data network. Further, the locally stored music 382 may be downloaded to the wireless device 320 from a user's computer that may be linked to the wireless device 320 via a wireless connection, e.g., Bluetooth. Further, the locally stored music 382 may be downloaded to the wireless device 320 from a user's computer via a wired connection, e.g., a universal serial bus (USB) connection.

In a particular aspect, the wireless device 320 may also include a playlist 384 and an interference/recommendation engine 386. The playlist 384 may be generated by an external server and transmitted to the wireless device 320. Further, the playlist 384 may be generated by the interference/recommendation engine 386 based on the locally stored music 382. The playlist 384, the interference/recommendation engine 386, an external interference/recommendation engine, or a combination thereof may provide a means for selecting one or more locally stored songs to be played at the wireless device 320 in the event that a streaming song at the wireless device 320 ends due to a network interruption.

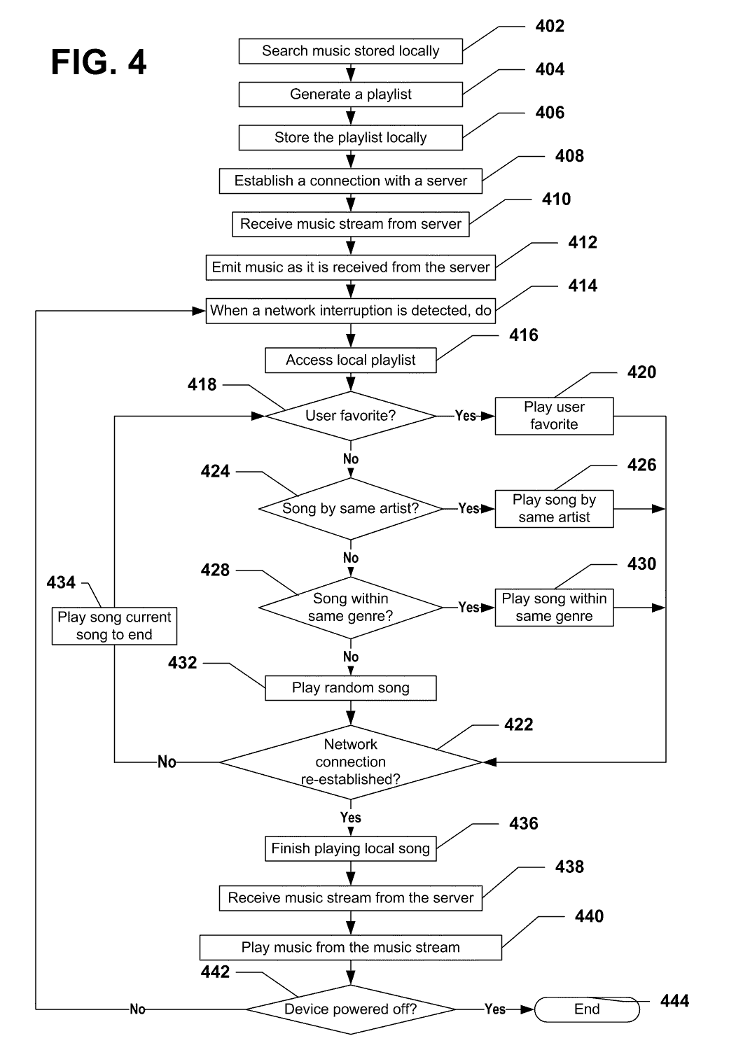

As depicted in FIG. 3, the touchscreen display 332, the video port 338, the USB port 342, the camera 348, the first stereo speaker 354, the second stereo speaker 356, the microphone 360, the FM antenna 364, the stereo headphones 366, the RF switch 370, the RF antenna 372, the keypad 374, the mono headset 376, the vibrator 378, and the power supply 380 are external to the on-chip system 322. Referring to FIG. 4, a method of replacing streaming music with local music when a network connection to a wireless device is interrupted is shown. Commencing at block 402, a wireless device, e.g., an inference/recommendation engine therein, may search the music stored locally at the wireless device. At block 404, the wireless device may generate a playlist. Thereafter, at block 406, the playlist may be stored locally on the wireless device. The playlist may also include songs that have been streamed to the wireless device or stored on a remote server.

At block 408, the wireless device may establish a connection with a music server, e.g., via a wireless network. At block 410, the wireless device may receive a music stream from the server. At block 412, the wireless device may emit music as it is received from the server.

Moving to block 414, a do loop may be entered, wherein when the wireless device detects a network interruption, the following steps may be performed. For example, at block 416, the wireless device may access the local playlist. Moreover, at decision 418, the wireless device may determine whether the local playlist includes one or more user favorites. The one or more user favorites may include favorites of the user that owns the wireless device. Further, the one or more user favorites may include favorites of other listeners. For example, if the user is listening to a song by a particular artist, a system may determine that other listeners that listen to that particular artist also listen to other similar artists. If the local playlist does include one or more user favorites, the method may move to block 420 and the wireless device may play the user favorite. Thereafter, the logic may move to decision 422, described below, and continue as described herein.

Returning to decision 418, if the playlist does not include any user favorites, method may move to decision 424 and the wireless device may determine whether the playlist includes a song by the same artist as the song that was playing when the network interruption occurred. If so, the method may move to block 426 and the wireless device may play the song by the same artist as the song that was playing when the network interruption occurred. Then, the method may move to decision 422, described below, and continue as described herein.

Returning to decision 424, if the playlist does not include a song by the same artist as the song that was playing when the network interruption occurred, the method may move to decision 428 and the wireless device may determine whether the playlist includes a song within the same genre as the song that was playing when the network interruption occurred. If yes, the method may continue to block 430 and the wireless device may play the song within the same genre as the song that was playing when the network interruption occurred. Thereafter, the method may proceed to decision 422, described below, and continue as described herein.

Returning to decision 428, if the playlist does not include a song within the same genre as the song that was playing when the network interruption occurred, the method may move to block 432. At block 432, the wireless device may play a random song from the playlist of locally stored songs.

Moving now to decision 422, the wireless device may determine whether the network connection is re-established. If the network connection is not re-established, the method may proceed to block 434 and the current song may be played to the end thereof. Thereafter, the method may return to decision 418 and continue as described herein. If the network connection is re-established, the method may move to block 436 and the wireless device may finish playing the local song. Thereafter, at block 438, the wireless device may receive a music stream from the server.

Continuing to block 440, the wireless device can, once again, play or emit music from the music stream. At decision 442, the wireless device may determine whether the wireless device is powered off. If so, the method may end at state 444. Otherwise, the method may return to block 414 and continue as described herein.

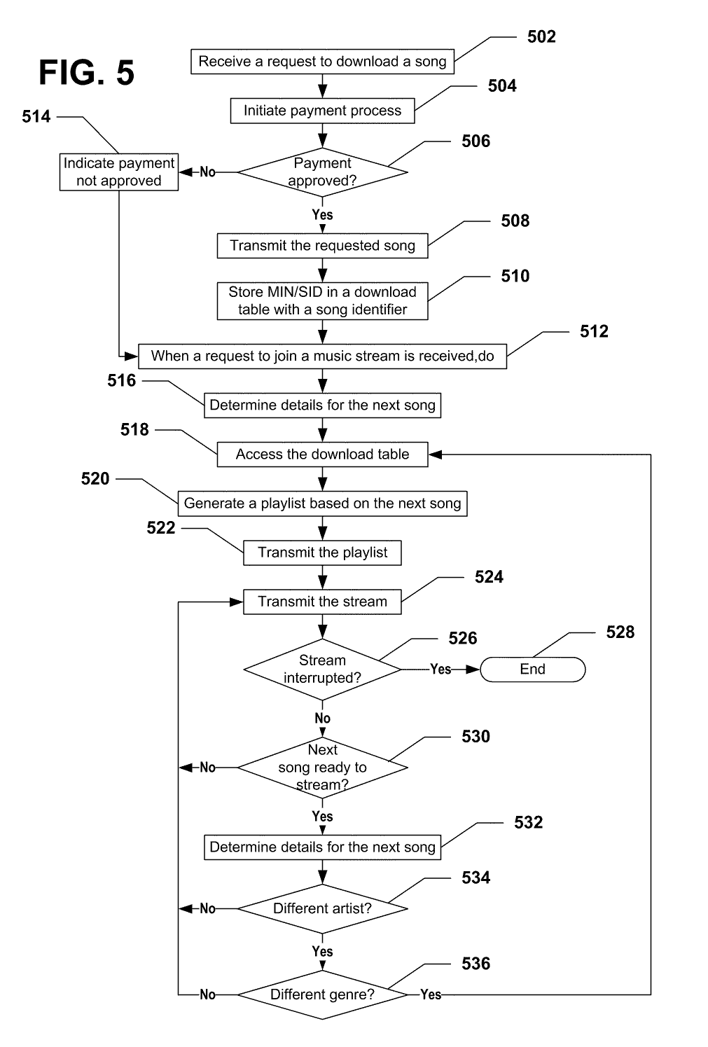

Referring now to FIG. 5, a method of generating a play list associated with streaming music to a wireless device is depicted, according to one aspect. Beginning at block 502, a download server may receive a request to download a song. At block 504, the server may initiate a payment process. Further, at decision 506, the server may determine whether payment is approved. If payment is approved, the method may move to block 508 and the server may transmit the requested song. Also, at block 510, the server may store a mobile identification number or SID in a download table with a song identifier. Then, the method may move to block 512, described below, and continue as described herein.

Returning to decision 506, if the payment is not approved, the method may move to block 514 and the server may indicate that payment is not approved. Thereafter, the method may move to block 512.

At block 512, when a request to join a music stream is received at the server, a do loop may be entered in which the following operations are performed. At block 516, the server may determine the details for the next song, e.g., the name of the song, the artist associated with the song, the genre associated with the song, etc. Moreover, at block 518, the server may access the download table in order to determine which songs have been downloaded to the requesting device. At block 520, based on the download table and the details for the next song, the server may generate a playlist for the requesting device. The server may also generate a playlist based on the details for the currently playing song. Those details may also include the name of the current song, the artist associated with the current song, the genre associated with the current song, etc.

Proceeding to block 522, the server may transmit the playlist to the requesting device. Further, at block 524, the server may transmit the stream to the requesting device.

Moving to decision 526, the server may determine whether the stream is interrupted. If so, the method may end at state 526. On the other hand, if the stream is not interrupted, the method may continue to decision 530. At decision 530, the server may determine whether the next song is ready to stream. If not, the method may return to block 524 and continue as described herein. Conversely, if the next song is ready to stream, the method may move to block 532 and the server may determine the details for the next song. Thereafter, the server may determine whether the next song has a different artist. If not, the method may return to block 524 and continue as described herein. If the artist is indeed different, the method may move to decision 536 and the server may determine whether a genre for the next song is different. If the genre is not different, the method may return to block 524 and continue as described. On the other hand, if the genre is different, the method may return to block 518 and continue as described.

One or more aspects described herein provide a way to replace streaming music with a locally stored song. The streaming music may be interrupted by a network failure. Alternatively, the streaming music may be interrupted when a wireless device is switched to an “airplane mode.” Further, the streaming music may be interrupted when a power supply, e.g., a battery, for a wireless device falls below a certain threshold. To conserve battery life for important calls, messages, or other activities the device may automatically switch from playing the streaming music to playing locally stored songs or music that are similar to the streaming music.

In one aspect, the streaming music may be replaced by a locally stored song performed by the same artist as the streaming song. Further, the streaming music may be replaced by music within the same genre as the streaming song. For example, a streaming hip-hop song may be replaced by a locally stored hip-hop song, a streaming country song may be replaced by a locally stored country song, streamed classical music may be replaced by locally stored classical music, etc. It may be appreciated, that the method may be employed for various other genres of music, e.g., rock, rap, alternative, punk, ska, reggae, blues, jazz, easy listening, etc.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium, or memory, that may be used to carry or store desired program code in the form of instructions or data structures and that may be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media.

Although selected aspects have been illustrated and described in detail, it will be understood that various substitutions and alterations may be made therein without departing from the spirit and scope of the present invention, as defined by the following claims.

What is claimed is:

1. A method of receiving streaming music at a wireless device, the method comprising:
receiving a music stream from a server;
emitting music from the music stream; and
playing a locally stored song, when a network interruption is detected.

2. The method of claim 1, further comprising:
accessing a playlist; and
determining whether the playlist includes at least one of a user favorite song, a same artist song, or a same genre song.

3. The method of claim 2, wherein the locally stored song is selected from a group including the user favorite song, the same artist song, the same genre song, and a random song.

4. The method of claim 2, further comprising:
determining that a network connection is re-established;
finishing playback of the locally stored song;
receiving another music stream from the server; and
emitting music from the other music stream.

5. The method of claim 2, further comprising:
determining that a network connection is re-established;
ceasing playback of the locally stored song;
receiving another music stream from the server; and
emitting music from the other music stream.

6. A wireless device used to access content, the wireless device comprising:
means for receiving a music stream from a server;
means for emitting music from the music stream; and
means for playing a locally stored song, when a network interruption is detected.

7. The wireless device of claim 6, further comprising:
means for accessing a playlist; and
means for determining whether the playlist includes at least one of a user favorite song, a same artist song, or a same genre song.

8. The wireless device of claim 7, wherein the locally stored song is selected from a group including the user favorite song, the same artist song, the same genre song, and a random song.

9. The wireless device of claim 7, further comprising:
means for determining that a network connection is re-established;
means for finishing playback of the locally stored song;
means for receiving another music stream from the server; and
means for emitting music from the other music stream.

10. The wireless device of claim 7, further comprising:
means for determining that a network connection is re-established;
means for ceasing playback of the locally stored song;
means for receiving another music stream from the server; and
means for emitting music from the other music stream.

11. A wireless device used to access content, the wireless device comprising:
a processor, wherein the processor is operable to:
receive a music stream from a server;
emit music from the music stream; and
play a locally stored song, when a network interruption is detected.

12. The wireless device of claim 11, wherein the processor is further operable to:
access a playlist; and
determine whether the playlist includes at least one of a user favorite song, a same artist song, or a same genre song.

13. The wireless device of claim 12, wherein the locally stored song is selected from a group including the user favorite song, the same artist song, the same genre song, and a random song.

14. The wireless device of claim 12, wherein the processor is further operable to:
determine that a network connection is re-established;
finish playback of the locally stored song;
receive another music stream from the server; and
emit music from the other music stream.

15. The wireless device of claim 12, wherein the processor is further operable to:
determine that a network connection is re-established;
cease playback of the locally stored song;
receive another music stream from the server; and
emit music from the other music stream.

16. A computer program device, comprising:
a computer-readable medium, comprising:
at least one instruction for receiving a music stream from a server;
at least one instruction for emitting music from the music stream; and
at least one instruction for playing a locally stored song, when a network interruption is detected.

17. The wireless device of claim 16, further comprising:
at least one instruction for accessing a playlist; and
at least one instruction for determining whether the playlist includes at least one of a user favorite song, a same artist song, or a same genre song.

18. The wireless device of claim 17, wherein the locally stored song is selected from a group including the user favorite song, the same artist song, the same genre song, and a random song.

19. The wireless device of claim 17, further comprising:
at least one instruction for determining that a network connection is re-established;
at least one instruction for finishing playback of the locally stored song;
at least one instruction for receiving another music stream from the server; and
at least one instruction for emitting music from the other music stream.

20. The wireless device of claim 17, further comprising:
at least one instruction for determining that a network connection is re-established;
at least one instruction for ceasing playback of the locally stored song;
at least one instruction for receiving another music stream from the server; and
at least one instruction for emitting music from the other music stream.

21. A method of transmitting streaming music to a wireless device, the server comprising:
receiving a request to join a music stream from a user device;
generating a playlist at least partially based on a next song;
transmitting the playlist to the user device; and
transmitting the music stream to the user device.

22. The method of claim 21, wherein the playlist includes a plurality of songs stored locally at the user device.

23. The method of claim 22, wherein the playlist further includes at least one of a user favorite song, a same artist song, or a same genre song.

24. The method of claim 21, further comprising:
determining a next song to stream;
determining that the next song is a different artist song; and
generating another playlist at least partially based on the different artist song.

25. The method of claim 24, further comprising:
transmitting the other playlist to the user device; and
transmitting the next song to the user device via the music stream.

26. The method of claim 21, further comprising:
determining a next song to stream;
determining that the next song is a different genre song; and
generating another playlist at least partially based on the different genre song.

27. The server of claim 26, wherein the processor is operable to:
transmitting the other playlist to the user device; and
transmitting the next song to the user device via the music stream.

28. A server, comprising:
means for receiving a request to join a music stream from a user device;
means for generating a playlist at least partially based on a next song;
means for transmitting the playlist to the user device; and
means for transmitting the music stream to the user device.

29. The server of claim 28, wherein the playlist includes a plurality of songs stored locally at the user device.

30. The server of claim 29, wherein the playlist further includes at least one of a user favorite song, a same artist song, or a same genre song.

31. The server of claim 28, further comprising:
means for determining a next song to stream;
means for determining that the next song is a different artist song; and
means for generating another playlist at least partially based on the different artist song.

32. The server of claim 31, further comprising:
means for transmitting the other playlist to the user device; and
means for transmitting the next song to the user device via the music stream.

33. The server of claim 28, further comprising:
means for determining a next song to stream;
means for determining that the next song is a different genre song; and
means for generating another playlist at least partially based on the different genre song.

34. The server of claim 33, further comprising:
means for transmitting the other playlist to the user device; and
means for transmitting the next song to the user device via the music stream.

35. A server, the server comprising:
a processor, wherein the processor is operable to:
receive a request to join a music stream from a user device;
generate a playlist at least partially based on a next song;
transmit the playlist to the user device; and
transmit the music stream to the user device.

36. The server of claim 35, wherein the playlist includes a plurality of songs stored locally at the user device.

37. The server of claim 36, wherein the playlist further includes at least one of a user favorite song, a same artist song, or a same genre song.

38. The server of claim 35, wherein the processor is further operable to:
determine a next song to stream;
determine that the next song is a different artist song; and
generate another playlist at least partially based on the different artist song.

39. The server of claim 38, wherein the processor is further operable to:
transmit the other playlist to the user device; and
transmit the next song to the user device via the music stream.

40. The server of claim 35, wherein the processor is further operable to:
determine a next song to stream;
determine that the next song is a different genre song; and
generate another playlist at least partially based on the different genre song.

41. The server of claim 40, wherein the processor is further operable to:
transmit the other playlist to the user device; and
transmit the next song to the user device via the music stream.

42. A computer program device, comprising:
a computer-readable medium, comprising:
at least one instruction for receiving a request to join a music stream from a user device;
at least one instruction for generating a playlist at least partially based on a next song;
at least one instruction for transmitting the playlist to the user device; and
at least one instruction for transmitting the music stream to the user device.

43. The computer program device of claim 42, wherein the playlist includes a plurality of songs stored locally at the user device.

44. The computer program device of claim 43, wherein the playlist further includes at least one of a user favorite song, a same artist song, or a same genre song.

45. The computer program device of claim 42, wherein the computer-readable medium further comprises:
at least one instruction for determining a next song to stream;
at least one instruction for determining that the next song is a different artist song; and
at least one instruction for generating another playlist at least partially based on the different artist song.

46. The computer program device of claim 45, wherein the computer-readable medium further comprises:
at least one instruction for transmitting the other playlist to the user device; and
at least one instruction for transmitting the next song to the user device via the music stream.

47. The computer program device of claim 42, wherein the computer-readable medium further comprises:
at least one instruction for determining a next song to stream;
at least one instruction for determining that the next song is a different genre song; and
at least one instruction for generating another playlist at least partially based on the different genre song.

48. The computer program device of claim 47, wherein the computer-readable medium further comprises:
at least one instruction for transmitting the other playlist to the user device; and
at least one instruction for transmitting the next song to the user device via the music stream.
